(19) United States
(12) Patent Application Publication
(10) Pub. No.: US 2008/0281687 A1
(43) Pub. Date: Nov. 13, 2008

(54) METHOD FOR DETERMINING USER INTEREST IN PRODUCTS AND SERVICES FOR TARGETED ADVERTISING

(75) Inventors: Joshua B. Hurwitz, Niles, IL (US); Miles R. Jackson, North Barrington, IL (US); David J. Wheatley, North Barrington, IL (US)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/745,729

(22) Filed: May 8, 2007

(51) Int. Cl. G06Q 30/00

(52) U.S. Cl. 705/14

(57) ABSTRACT

A method and apparatus that selects and sends advertisements to a user based on the user's interests as determined by the user's location information is disclosed. The method may include receiving a user's location information, updating the user's location history based on the received location information, updating the user's interest profile based on the updated location history information, selecting one or more advertisement based on the updated user's interest profile, and transmitting the selected one or more advertisement for presentation to the user.

### BACKGROUND OF THE INVENTION

1. Field of the Invention

The invention relates to mobile communication networks.

2. Introduction

There are various conventional methods of predicting a user's interest in advertisements. One method concerns deriving predictions from the user's responses to related content items presented previously on their mobile devices, such as text articles or other advertisements. Another method concerns the use of responses to particular advertisements from other users having similar characteristics to the current user (collaborative filtering).

However, one of the problems with these approaches is their dependence on actual user responses to items or advertisements. A user may have some interest in a product or service, but the system can only record this fact 1) if one or more items (e.g., advertisements or content items) that can be used to predict this interest have been presented on the device and 2) the user has provided some detectable response to these items, such as selecting the item for further information, or purchasing the advertised products or services using an m-commerce application that records the purchase on the mobile device. The absence of information about such responses prevents the system from accurately predicting that user's level of interest, thereby limiting its ability to target the advertising and diminishing the effectiveness of mobile advertising and marketing.

### SUMMARY OF THE INVENTION

A method and apparatus that selects and sends advertisements to a user based on the user's interests as determined by the user's location information is disclosed. The method may include receiving a user's location information, updating the user's location history based on the received location information, updating the user's interest profile based on the updated location history information, selecting one or more advertisement based on the updated user's interest profile, and transmitting the selected one or more advertisement for presentation to the user.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary diagram of a communications network environment in accordance with a possible embodiment of the invention;

FIG. 2 illustrates a block diagram of an exemplary mobile communication device in accordance with a possible embodiment of the invention;

FIG. 3 illustrates a block diagram of an exemplary personalized advertising selection unit in accordance with a possible embodiment of the invention; and

FIG. 4 is a flowchart illustrating an exemplary personalized advertisement selection process in accordance with a possible embodiment of the invention.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The invention comprises a variety of embodiments, such as a method and apparatus and other embodiments that relate to the basic concepts of the invention.

The invention concerns presenting advertisements and promotions on a mobile or fixed device that are of maximum relevance and interest to the device user based upon their patterns of visits to known businesses, categories of business, etc. For example, one embodiment may include a system that may select personalized advertising based upon an interest metric, where the interest metric is derived at least in part from tracking the location of the user over time.

Below are definitions which will be used throughout in the discussion:

An “interest” may be something that concerns, involves, draws the attention of, or arouses the curiosity of a person.

A “user interest” may be something that concerns, involves, draws the attention of, or arouses the curiosity of a particular user associated with a mobile communications device.

An “interest metric” may be a set of one or more pieces of data, including at least one quantitative element, representative of a level of importance attached to a user interest.

A “user interest metric” may be an interest metric associated with a particular user.

A “user interest profile” may be a collection of data which includes the user interest metrics associated with a particular user.

“Interests” and “user interests” may be found in the real world. “Interest metrics,” “user interest metrics,” and “user interest profiles” are found within our system and form a part of the model of the real-world concepts.

A “geographical area” may be a bounded region of the planet. It may be bounded by a variety of means known in the art. For example: a range of coordinates, such as latitude, longitude, and altitude. Another example is known as metes and bounds whereby a starting point is identified and a path enclosing the geographical area is described. Another example is defining an area by proximity: The area within 10 miles of a user, or the area within 500 meters of Buckingham Fountain in Chicago. Another example is by reference: The 15th floor of the Sears Tower, the Atrium of the Motorola Innovation Center. All of these and more are ways of specifying a geographical area.

The term “area” may be used interchangeably with “geographical area.”

A “zone” may be a data construct within the system associated with one interest metric and one geographical area pertinent to that interest metric.

“Geographical areas” may exist in the real world and as such a user may visit them from time to time. Zones may exist within the system and the user can not visit a zone. There may be many interests associated with an area, but there is preferably one and only one interest metric associated with a zone. Many zones may exist corresponding to the exact same geographical area. Many zones may exist corresponding to approximately the same geographical area, having some of these zones defining the area slightly differently than others, as is best suited to the purposes of their associated interest metrics.

The embodiments described herein overcome the limitations of the prior art by developing a level of interest metric for various products, services or businesses for each device user without need for an actual user response to a presented advertisement or other item. These user interest indicators will help target advertising so that users are more likely to be presented with advertisements that relate to their interests and activities. This method will increase the probability that they remember the advertisements, respond to them, visit the advertised business locations, and purchase the advertised products or services. Thus, the method will increase the impact of mobile advertising and reduce negative user response to irrelevant or intrusive advertising.

The embodiments described below may include a system to track the user's movements and location, and an advertisement selection unit that receives the tracking information, determines if the user was present at any business locations, and selects appropriate advertising to send to the user.

The embodiments described below supply independent updating functions for each user interest and for areas visited by the user. Each area may be associated with multiple user interests. Accordingly, a user may be visiting that area for only one of those many user interests associated with that area. The embodiments are able to differentiate and determine which user interests are relevant to a particular user.

The embodiments described also allow zones of one interest to overlap and/or be independent of zones of another interest. For example, a brief visit to an area may be processed differently for interest A than for interest B. Duration of these visits may also be a factor that is considered in accordance with the embodiments herein.

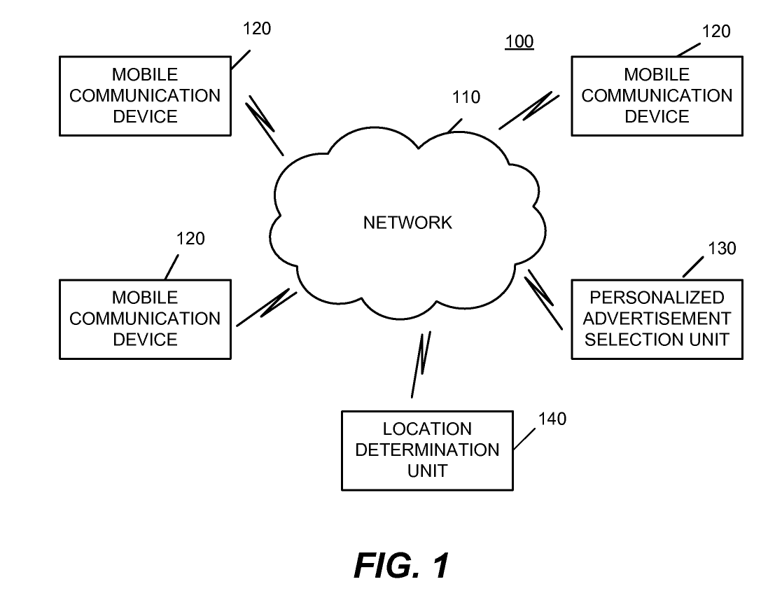

FIG. 1 illustrates an exemplary diagram of a mobile communications network environment 100 in accordance with a possible embodiment of the invention. In particular, the mobile communication network environment 100 may include a plurality of mobile communication devices 120, a personalized advertising selection unit 130, and a location determination unit 140 connected via network 110.

While FIG. 1 only shows three mobile communication devices 120, this example is for ease of discussion as one of skill in the art may appreciate that more than three mobile communication devices 120 (or a plurality of mobile communication devices) may exist per group in the mobile communications network environment 100.

The mobile communication device 120 may be a portable MP3 player, satellite radio receiver, AM/FM radio receiver, satellite television, portable music player, portable computer, wireless radio, wireless telephone, portable digital video recorder, cellular telephone, mobile telephone, personal digital assistant PDA), or combinations of the above, for example.

The location determination unit 140 is a device external to the mobile communication devices 120 that may record itself or assist the mobile communication device 120 in determining its location. For example, the location determination unit 140 may operate in conjunction with a camera, sensor or other remote device that may recognize the user and records (or assist in recording) the user's location. The information collected by the location determination unit 140 may be transmitted directly or through the communications network 110 to the personalized advertisement selection unit 130.

The mobile communications network environment 100 illustrated in FIG. 1 and the related discussion are intended to provide a brief, general description of a suitable computing environment in which the invention may be implemented. Although not required, the invention will be described, at least in part, in the general context of computer-executable instructions, such as program modules, being executed by the personalized advertising selection unit 130. Generally, program modules include routine programs, objects, components, data structures, etc. that perform particular tasks or implement particular abstract data types. Moreover, those skilled in the art will appreciate that other embodiments of the invention may be practiced in communication network environments with many types of communication equipment and computer system configurations which operate from batteries, including cellular network devices, mobile communication devices, portable computers, hand-held devices, portable multi-processor systems, microprocessor-based or programmable consumer electronics, and the like.

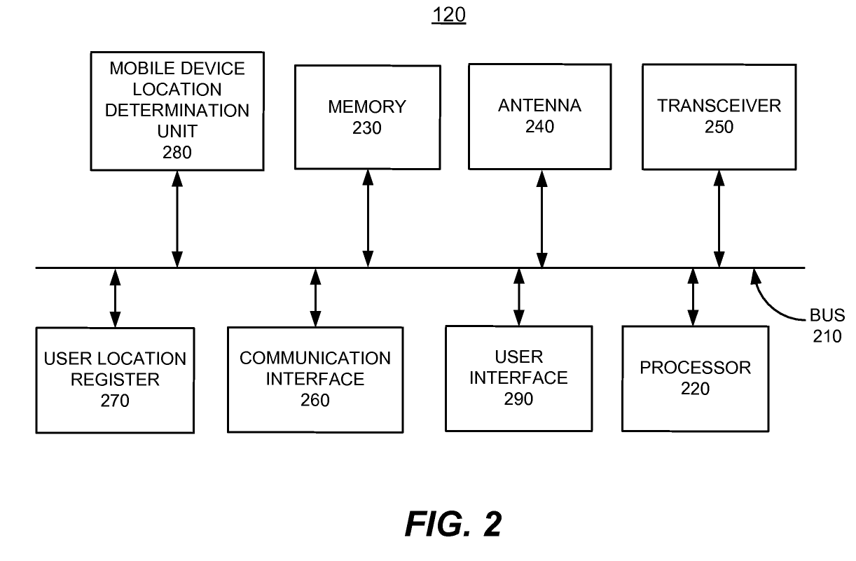

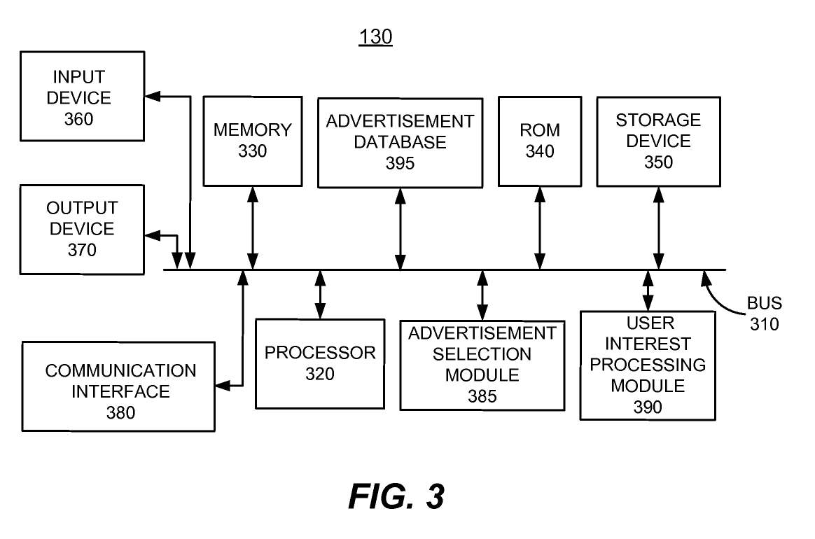

The mobile communications device 120 and the personalized advertising selection unit 130 will be described further below in relation to FIGS. 2 and 3, respectively.

FIG. 2 illustrates a block diagram of an exemplary mobile communications device 120 in accordance with a possible embodiment of the invention. The mobile communications device 120 may include a bus 210, a processor 220, a memory 230, an antenna 240, a transceiver 250, a communication interface 260, a user location register 270, a mobile device location determination unit 280, and a user interface 290. Bus 210 may permit communication among the components of the mobile communication device 110.

Processor 220 may include at least one conventional processor or microprocessor that interprets and executes instructions. Memory 230 may be a random access memory (RAM) or another type of dynamic storage device that stores information and instructions for execution by processor 220. Memory 230 may also include a read-only memory (ROM) which may include a conventional ROM device or another type of static storage device that stores static information and instructions for processor 220.

Transceiver 250 may include one or more transmitters and receivers. The transceiver 250 may include sufficient functionality to interface with any network or communications station and may be defined by hardware or software in any manner known to one of skill in the art. The processor 220 is cooperatively operable with the transceiver 250 to support operations within the communications network 110. The transceiver 250 transmits and receives transmissions via one or more of the antennae 240 in a manner known to those of skill in the art.

Communication interface 260 may include any mechanism that facilitates communication via the network 110. For example, communication interface 260 may include a modem. Alternatively, communication interface 260 may include other mechanisms for assisting the transceiver 250 in communicating with other devices and/or systems via wireless connections.

User interface 290 may include one or more conventional input mechanisms that permit a user to input information, communicate with the mobile communication device 110, and/or present information to the user, such as a an electronic display, microphone, touchpad, keypad, keyboard, mouse, pen, stylus, voice recognition device, buttons, one or more speakers, etc.

While the mobile communication device 120 is shown as an example, one of skill in the art may appreciate that any known or future-developed combination of location determination systems may be used to track the location of the user. The user location register 270 is used to store the locations of the user as determined by the mobile device location determination unit 280 via a global positioning system (GPS) device, for example.

For instance, in one possible manner to perform the user location tracking process, the mobile device location determination unit 280 may periodically record the location of the mobile communication device 120 and its user in the user location register 270, at various times. At predetermined times or when requested by the personalized advertising selection unit 130, a file containing the user's location/time information may be compressed and periodically uploaded to the personalized advertising selection unit 130. The file may then be deleted from the user's mobile communication device 120. To minimize network load, the user's location/time file and identity information may be uploaded during periods of reduced or idle network traffic, such as the middle of the night, for example.

The mobile communication device 120 may perform such functions in response to processor 220 and/or mobile device location determination unit 280 by executing sequences of instructions contained in a computer-readable medium, such as, for example, memory 230. Such instructions may be read into memory 230 from another computer-readable medium, such as a storage device or from a separate device via communication interface 260.

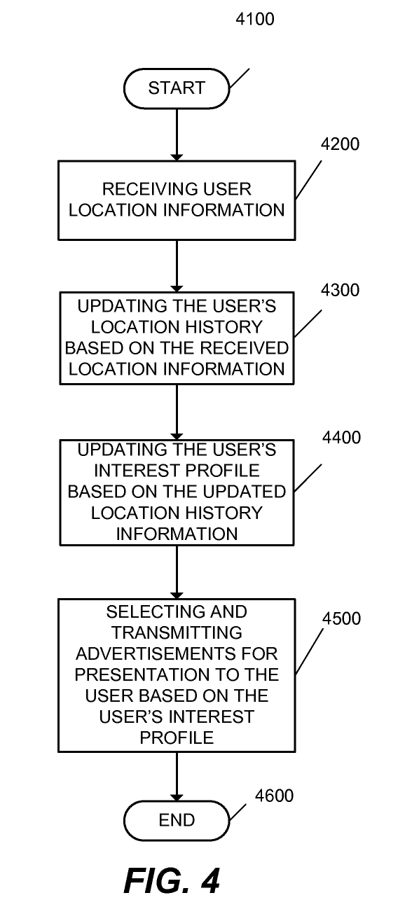

FIG. 3 illustrates an exemplary personalized advertising selection unit 130, or device which may implement one or more modules or functions of the personalized advertising selection process shown below in FIG. 4. Thus, the exemplary personalized advertising selection unit 130 may include a bus 310, a processor 320, a memory 330, a read only memory (ROM) 340, a storage device 350, an input device 360, an output device 370, a communication interface 380, advertisement selection module 385, a user interest processing module 390, and advertisement database 395. Bus 310 may permit communication among the components of the personalized advertising selection unit 130.

Processor 320 may include at least one conventional processor or microprocessor that interprets and executes instructions. Memory 330 may be a random access memory (RAM) or another type of dynamic storage device that stores information and instructions for execution by processor 320. Memory 330 may also store temporary variables or other intermediate information used during execution of instructions by processor 320. ROM 340 may include a conventional ROM device or another type of static storage device that stores static information and instructions for processor 320. Storage device 350 may include any type of media, such as, for example, magnetic or optical recording media and its corresponding drive.

Input device 360 may include one or more conventional mechanisms that permit a user to input information to the personalized advertising selection unit 130, such as a keyboard, a mouse, a pen, a voice recognition device, etc. Output device 370 may include one or more conventional mechanisms that output information to the user, including a display, a printer, one or more speakers, or a medium, such as a memory, or a magnetic or optical disk and a corresponding disk drive.

Communication interface 380 may include any transceiver-like mechanism that enables the personalized advertising selection unit 130 to communicate via a network. For example, communication interface 380 may include a modem, or an Ethernet interface for communicating via a local area network (LAN).

Alternatively, communication interface 380 may include other mechanisms for communicating with other devices and/or systems via wired, wireless or optical connections. In some implementations of the network environment 100, communication interface 380 may not be included in the exemplary personalized advertising selection unit 130 when the advertisement selection process is implemented completely within the personalized advertising selection unit 130.

The advertisement database 395 may store a plurality of advertisements, coupons, etc. which may be passed on to the user via the advertisement selection module 385. The advertisements stored in the advertisement database 395 may be categorized according to particular user interests, location, price, style, etc.

The personalized advertising selection unit 130 may perform such functions in response to processor 320 by executing sequences of instructions contained in a computer-readable medium, such as, for example, memory 330, a magnetic disk, or an optical disk. Such instructions may be read into memory 330 from another computer-readable medium, such as storage device 350, or from a separate device via communication interface 380.

The operation of the user interest processing module 390, advertisement selection module 385, and advertisement selection process will be described further below in relation to the flowchart in FIG. 4

FIG. 4 illustrates an exemplary personalized advertisement selection process in accordance with a possible embodiment of the invention. The personalized advertising selection unit 130 is responsible for two primary functions which occur at different times. The first is the computation of interest metrics for each user based upon location/time information received from the mobile communication device 120. For each upload of location/time information the personalized advertising selection unit 130 receives, it performs processes which use that information to make the indicated updates to the interest metrics for that user.

The second function of the personalized advertising selection unit 130 is to select appropriate advertising for presentation to the user, based at least in part, upon the interest metrics.

The process begins at step 4100 and goes to step 4200 where the user interest processing module 390 included in the personalized advertising selection unit 130 receives user location information from the user's mobile communication device 120 or external sources such as from the location determination unit 140. As stated above, the user location information also contains information to identify the user of the mobile communication device in order to locate the user's profile and location history.

At step 4300, the user interest processing module 390 updates the user's location history based on the received location information. At step 4400, the user interest processing module 390 updates the user's interest profile based on the updated location history information.

In this step, the user interest processing module 390 may process the location data to determine “dwell events.” A dwell event is one in which the location of the user or mobile communication device 130 does not change significantly for a period of time exceeding a given threshold.

Associated with each interest identified by the user interest processing module 390 may be a list of zones related to that interest, and each zone has an associated interest metric function which defines how the interest metric may be modified based on the parameters of a given dwell event. Also associated with each zone may be zone state parameters (ZSPs), such as the number or details of previous dwell events detected for this user in this interest zone. As an example, the “presence frequency” may be calculated as the number of times a user visits this zone per month, or per year.

The interest zones for a particular interest can be determined in a large variety of ways familiar to one skilled in the art. A large variety of public geographical information service (GIS) data is available. For example, tax records and land-use data are available from which one can determine the locations of restaurants and other businesses. Web crawling technologies can be used to extract addresses and keywords from information available on the World Wide Web (WWW). The addresses can be correlated to specific latitude and longitude using available reverse geocoding services. Updates to the interest metric database, which may be stored in memory 330, can be determined automatically by such a manner, or such updates can be suggested in an automated fashion and reviewed by human personnel to ensure information quality before committing the changes to the interest database.

It is important to note that the interest zones for a particular interest can vary over time and the system as described will handle such situations. For example, a fairground may have an antiques show one day, and a car collector's show the following day.

Such a situation may be handled by the user interest processing module 390 by having the “antiques” interest include a zone covering the fairgrounds, while the zone's interest metric function would only increase interest in the category if the dwell event in that zone was during the time of the antiques show. Similarly, the “auto collecting” interest would include a zone covering the fairgrounds, and that zone's interest metric function would only increase interest in the “auto collecting” category if the dwell event in that zone was during the time of the car collector's show.

Such time-dependent zones may have an expiration, so that the zone description might be deleted from the database when it becomes unlikely that new location information might be received by the user interest processing module 390 related to that time dependency. This feature, and others generally known in the art, is used to maintain the interest database and to keep it from unchecked growth.

In one possible embodiment, when the mobile communication device 120 is found to be in a certain location or category of locations for a minimum amount of time, the user interest processing module 390 can use this to compute an overall level of interest metric. Note also that the user interest processing module 390 may augment the received location/time information or “dwell events” with information received from external sources (i.e., not received from the mobile communication device 120). For example, the user interest processing module 390 may use information such as sales information from a Point-of-Sale (POS) terminal, subscription information, user survey information, and the user's demographics

This external information may be added to the dwell events, prior to or during the updating of the interest metric so that such information can be integrated into and reflected by, the interest metric.

At step 4500, the advertisement selection module 385 selects appropriate advertisements from the advertising database 395 based on the user's interest profile and transmits those advertisements for presentation to the user. The advertisements may include coupons, promotional material, contests, etc. for shops, stores, restaurants, etc. that the user may have visited, a competitor thereof, or which his interest metric indicates he/she might want to visit. The process then goes to step 4600 and ends.

The information recorded by the mobile device location determination unit 280 or location determination unit 140 may include latitude (4 bytes), longitude (4 bytes), (altitude (2 bytes)) and time (7 bytes). Recording this data at one-minute intervals, for example, results in a file size of approximately 25K bytes (uncompressed) for 24 hours of data. Known techniques may be used to significantly reduce the file size, such as compressing the file or only recording changes in location which exceed a predefined threshold, for example.

The user interest processing module 390 may filter the user's received location information to reduce the collection of irrelevant location information. For example, exceptionally long, weekday only dwell times, might indicate that this is the user's place of employment which should not form part of the generation of an interest metric.

The location determination unit 140 or the mobile device location determination unit 280 may assign a confidence level to each location determination in order to compensate for errors in location determination. The confidence level may be represented in a number of ways including an overall confidence in the location reading, confidence measures for each parameter of the location data, or as a distance establishing a confidence radius for the location estimation, for example.

The mobile device location determination unit 280 and/or location determination unit 140 may make location estimates by querying the location capabilities of the wireless networks with which the mobile communication device 120 has established connections and the mobile device location determination unit 280 and/or location determination unit 140 may compile the various location estimates available into the required location/time information and forward that information to the personalized advertising selection unit 130. In essence, the mobile device location determination unit 280 and/or location determination unit 140 may be responsible for constructing a dataset which describes the location of the user over time.

In one particular embodiment, the personalized advertisement selection unit 130 may communicate the parameters of times or durations of interest to the mobile device location determination unit 280 and/or location determination unit 140, and the mobile device location determination unit 280 and/or location determination unit 140 may forward location data only for times or durations meeting these criteria. For example, the personalized advertisement selection unit 130 may ask only for times when the user spent an amount of time that exceeds a certain threshold and meets proximity data from fixed wireless stations with known latitude and longitude. The mobile device location determination unit 280 and/or location determination unit 140 would then reduce the data forwarded to only the data matching these criteria.

The personalized advertising selection process proceeds as a prioritization of available advertising offered. Through methods known in the art, a set of advertising available to be offered to the user is determined by the advertisement selection module 385 from the advertisement database 395. The advertisement selection module 385 uses the user's determined interest metrics, along with other optional information, to determine one or more advertisements most appropriate to this user at the appropriate time. These advertisements may be communicated to the user of the mobile communication device 120, through e-mail, postal mail, voice mail, text messages, or any other method known to those of skill in the art.

In one possible embodiment, the advertisement selection module 385 may receive regularly updated analyses of each user's interests from the user interest processing module 390 and maintains a prioritized list of advertisements appropriate to a particular user. In response to a request for an advertisement, or set of advertisements, the advertisement selection module 385 may simply return the number of requested advertisements from the top of the priority list. The list may then be updated to account for the fact that the most appropriate advertisements for the next request are affected by what advertisements were previously presented. This allows the advertisement selection module 385 to avoid offering the same advertisement multiple times.

In another possible embodiment, the advertisement selection module 385 may, in response to the analysis performed for each user by the user interest processing module 390, establish a queue of recommended advertisement events, including the appropriate time for the events, for each user. The advertisement selection module 385 would then push the recommended advertisement, or set of advertisements, to the user.

As an example, consider the case in which data received from a user's mobile communication device 120 or the location determination unit 140 indicating that the user frequently visits two competing electronic appliance stores. Given that these locations fall within the category “retail consumer electronics” interest category in the advertisement database 395, the user interest processing module 390 can use these data to generate metrics indicating the user's interest in consumer electronics generally, as well as in these specific commercial establishments. This result can then be used by the user interest processing module 390 to predict the likelihood that the user will be receptive to promotional messages for products, services and commercial establishments in this category.

As described previously, in one possible embodiment, the interest metrics may be computed as time-dependent functions, such that the system can identify periodic patterns of the user's interests. This permits the advertisement selection module 385 to present advertisements to a particular user at the appropriate time, since it may receive data on when the user's interest in a category typically peaks from the user interest processing module 390. Additionally, the advertisement selection module 385 may receive, as state parameters for each zone (ZSPs), other summary statistics, such as the mean or median time of day that the user typically enters the establishment from the user interest processing module, and may use these to determine the optimum time for presenting an advertisement or promotion.

The criteria for ZSPs may also vary. For example, dwell time criteria may vary (e.g., Starbucks—10 min., golf course—4 hrs., state park—1 day), frequency criteria may vary (e.g., Starbucks—once per day, golf course once per week, state park once per year), the geographical boundary criteria may vary (e.g., Starbucks ±20 yds., golf course ±1 mile, state park ±10 miles).

As also discussed above, the user interest processing module 390 may augment user location/time information with POS (Point of Sale) information to further differentiate between visits which resulted in a purchase and those which did not. This augmentation may be used to change the nature of the advertisement presented. For example, if a purchase was not made, then related advertisements could be delivered, and if a purchase was made, then loyalty discounts or promotions may be delivered.

If the user interest processing module 390 also has access to information about characteristics (e.g., demographics, content interests, and prior responses to advertising) shared by users who have entered one or more relevant establishments, and if it has made predictions about which advertisements these users may be interested, then the advertisement selection module 385 could provide the same advertisements to other users who have similar characteristics but for whom there is no data indicating that they have been inside the relevant establishments—a form of collaborative filtering known in the art.

Other summary statistics such as the mean or median time of day that the user typically entered the establishment, and the mean or median amount of time spent there over some time period may also be a factor in determining the optimum timing for presentation of an advertisement or promotion. For example, the advertisement selection module 385 could also estimate the times of day that a user would most likely be receptive to the advertising. It would do this when selecting advertisements from businesses that the user has previously visited or those that are in the same category. It would base its estimates on summary statistics, such as the mean or median time of day that the user has entered those establishments.

For example, the advertisement selection module 385 could present advertisements for Indian restaurants to a user between 11:00 AM and 1:00 PM if it determines that the user tends to go those restaurants at lunchtime. Note that while the mobile device location determination unit 280 may or may not detect a user's presence at a commercial establishment until after the location data for that user is uploaded to the user interest processing module 390, user interest processing module 390 may download to the client coordinates for establishments that the user visits frequently. The mobile location determination unit 280 may then use this data to detect when the user is in the vicinity of one of his/her preferred establishments and present advertisements (or stop presenting the advertisements after it detects that the user is at another restaurant) during lunchtime.

The personalized advertisement selection unit 130 may also be used for targeted advertising on a fixed device using data collected by the mobile communication device 120 or the location determination unit 140. For example, the interest metric may be generated and updated for a given user as described above, but the targeted advertising could be directed to that user's television via the IPTV network, to an MP3 player, or to the user's computer via the Internet, or any other visual display equipped communications device, for example.

If the user interest processing module 390 also has access to information about the characteristics of users (e.g., demographics, content interests, and prior responses to advertising) who have visited one or more relevant businesses, and if it has made predictions about which advertisements would be of interest to these users, then the advertisement selection module 385 could provide the same advertisements to other users who have similar characteristics but for whom there are no data indicating that they have visited those businesses.

For example, consider the case in which the user interest processing module 390 has found a cluster of users group “A”) who 1) tend to shop at a home improvement store and 2) have certain interests and demographic characteristics stored in their personal profiles (e.g., being homeowners who like science, engineering and art). Based on their trips to the home improvement store, the advertisement selection module 385 would present them with advertisements for home improvement products.

If there were enough such users in group A, the advertisement selection module 385 could also present the advertisements to other users group “B”) who have similar characteristics stored in their personal profiles, even if it has no record of them having shopped at the home improvement store. The group-B users might be interested in home improvement products, but it may not be possible for the personalized advertisement selection unit 130 to record the fact that they shop at a home improvement store because 1) they only shop online, 2) their mobile communication device 120 does not have the hardware and software to work with the personalized advertisement selection unit 130, or 3) they have the user location determination service but, for technical reasons (e.g., no available signals for computing location), the personalized advertisement selection unit 130 cannot record their presence at the home improvement store near their home.

In any case, the personalized advertisement selection unit 130 may rely on similarities between the profiles of the two groups to predict that the users in group B would also be receptive to advertisements for home improvement products. The personalized advertisement selection unit 130 could then try to find support for its prediction by presenting advertisements that invite users to respond to the advertisement (e.g., selecting the advertisement to receive a special promotional item or to get more information about the establishment).

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the personalized advertising selection unit 130 in FIGS. 1 and 3 each processing the content in various possible ways. It does not necessarily need to be one system used by all end users. Accordingly, the appended claims and their legal equivalents should only define the invention, rather than any specific examples given.

We claim:

1. A method for selecting and sending advertisements to a user based on the user's interests as determined by the user's location information, comprising:
receiving a user's location information;
updating the user's location history based on the received location information;
updating the user's interest profile based on the updated location history information;
selecting one or more advertisement based on the updated user's interest profile; and
transmitting the selected one or more advertisement for presentation to the user.

2. The method of claim 1, further comprising:
determining one or more geographical areas associated with an interest metric; and
processing an update of the interest metric when a location in the user's location history corresponds to one of the geographical areas associated with the interest metric.

3. The method of claim 2, wherein the interest metric update may be different for each of the geographical areas associated with the interest metric.

4. The method of claim 1, further comprising:
augmenting the location history information with information received from sources other than the user's mobile communication device; and
updating the user's interest profile based on the location information and other source information.

5. The method of claim 4, wherein the other source information is at least one of point of sale transaction information, subscription information, user survey information, information about user consumption of content, previously stored location history information, and the user's demographics.

6. The method of claim 1, wherein the mobile communication device is one of a portable MP3 player, satellite radio receiver, AM/FM radio receiver, satellite television, satellite telephone, portable music player, portable laptop, portable computer, wireless radio, wireless telephone, portable digital video recorder, cellular telephone, mobile telephone, and personal digital assistant.

7. The method of claim 1, wherein the one or more advertisement sent to the user includes at least one of promotional material, one or more coupons, and content materials.

8. The method of claim 1, further comprising:
filtering the user's location information to eliminate irrelevant location information, wherein the user's location information is filtered based on at least one of duration of a location information event, repetition of a location information event, and the user's demographics.

9. An apparatus that selects and sends advertisements to a user based on the user's interests as determined by the user's location information, comprising:
an advertisement database that stores a plurality of advertisements; and
a user interest processing module that receives a user's location information, updates the user's location history based on the received location information, updates the user's interest profile based on the updated location history information; and
an advertisement selection unit that selects one or more advertisement from the advertisement database based on the updated user's interest profile, and transmitting the selected one or more advertisement for presentation to the user.

10. The apparatus of claim 9, wherein the user interest processing module determines one or more geographical areas associated with an interest metric, and processes an update of the interest metric when a location in the user's location history corresponds to one of the geographical areas associated with the interest metric.

11. The apparatus of claim 10, wherein the interest metric update may be different for each of the geographical areas associated with the interest metric.

12. The apparatus of claim 9, wherein the user interest processing module augments the location information in the user's profile with information received from sources other than the user's mobile communication device, and determines the user's interests based on the location information and other source information in the user's profile.

13. The apparatus of claim 11, wherein the other source information is at least one of point of sale transaction information, subscription information, user survey information, information about user consumption of content, previously stored location history information, and the user's demographics.

14. The apparatus of claim 9, wherein the mobile communication device is one of a portable MP3 player, satellite radio receiver, AM/FM radio receiver, satellite television, satellite telephone, portable music player, portable laptop, portable computer, wireless radio, wireless telephone, portable digital video recorder, cellular telephone, mobile telephone, and personal digital assistant PDA).

15. The apparatus of claim 9, wherein the advertisement selection unit sends one or more advertisement to the user that includes at least one of promotional material, one or more coupons, and content materials.

16. The apparatus of claim 9, wherein the user interest processing module filters the user's location information to eliminate irrelevant location information based on at least one of duration of a location information event, repetition of a location information event, and the user's demographics.

17. A mobile communication device, comprising:
a user location register;
a mobile device location determination unit that determines a user's location information and stores the determined user location information to the user location register; and
a transceiver that transmits the stored user location information to a personalized advertising selection unit.

18. The mobile communication device of claim 17, wherein the transceiver transmits the user's location information after at least one of a predefined time period expires and upon receiving a request from the personalized advertising selection unit.

19. The mobile communication device of claim 17, further comprising:
receiving advertisements from the personalized advertising selection unit; and
presenting the advertisements to the user.

20. The mobile communication device of claim 17, wherein the mobile communication device is one of a portable MP3 player, satellite radio receiver, AM/FM radio receiver, satellite television, satellite telephone, portable music player, portable laptop, portable computer, wireless radio, wireless telephone, portable digital video recorder, cellular telephone, mobile telephone, and personal digital assistant PDA).
